(19) United States
(12) Patent Application Publication
(10) Pub. No.: US 2013/0328437 A1
(43) Pub. Date: Dec. 12, 2013

(54) STATOR CORE FOR A GEARLESS DRIVE OF A TUBE MILL

(71) Applicant: ABB Schweiz AG, Baden (CH)

(72) Inventors: Axel FUERST, Rufenach (CH); Christian Horstmann, Olten (CH)

(73) Assignee: ABB SCHWEIZ AG, Baden (CH)

(21) Appl. No.: 13/964,634

(22) Filed: Aug. 12, 2013

Related U.S. Application Data
(63) Continuation of application No. PCT/EP2012/051913, filed on Feb. 6, 2012.

(30) Foreign Application Priority Data
Feb. 10, 2011 (EP) 11154075.3

(51) Int. Cl. H02K 1/18

(52) U.S. Cl. CPC H02K 1/185
USPC 310/216.009

(57) ABSTRACT

A stator core with a high stiffness is disclosed for a gearless drive of a tube mill, the stator core, together with a stator frame, forming a stator for a gearless drive for a tube mill, and the stator core being assembled from stator core pieces. The stator core pieces can be connected to one another in the direction of rotation of the tube mill, independently of the stator frame.

### RELATED APPLICATION

This application claims priority as a continuation application under 35 U.S.C. §120 to PCT/EP2012/051913, which was filed as an International Application on Feb. 6, 2012 designating the U.S., and which claims priority to European Application 11154075.3 filed in Europe on Feb. 10, 2011. The entire contents of these applications are hereby incorporated by reference in their entireties.

### TECHNICAL FIELD

The present disclosure relates to the field of gearless drives of tube mills. It relates, for example, to a stator core for holding stator windings for a gearless drive of a tube mill.

### BACKROUND INFORMATION

Tube mills are used for grinding ores, such as copper ores. Other material to be ground, such as cement products, can also be ground in tube mills. Here, a mill body of a tube mill is aligned with an axis of rotation transversely with respect to a gravitational field and is set into rotational movement about the axis of rotation by a drive.

As disclosed in U.S. Pat. No. 3,272,444, in large tube mills, a gearless drive is often used to carry out the rotational movement. In this case, a rotor of the gearless drive is fitted directly to the mill body. As a mating piece, a stator is arranged externally around the rotor. The stator, which can have, for example, a diameter of 6 to 15 m, can include a stator core and a stator frame. For transport, the stator core is subdivided into stator core pieces, which can also be designated stator core parts. Between 2 and 6 stator core pieces are exemplary of a gearless drive. The stator core holds stator windings. The stator core is connected to a foundation and fixed mechanically in its position via the external stator frame. For operational safety, the stiffness of the stator should be as high as possible in order to avoid vibration problems.

In known stator cores, the stator core pieces are connected only to the stator frame, so that a connection between the stator core pieces is made only indirectly via the stator frame. In this case, the stator core makes only a small contribution to the stiffness of the stator, since the latter is divided. In this case, it is primarily the stator frame that determines the stiffness of the stator. As a result, increased expenditure on material in the stator frame and, consequently, also in the stator is involved.

### SUMMARY

A stator core is disclosed for holding stator windings for a gearless drive of a tube mill, the stator core comprising: a stator core, together with a stator frame, forming a stator for a gearless drive for a tube mill; and stator core pieces being assembled to form the stator core, the stator core pieces being connected to one another in an intended direction of rotation of the tube mill, independently of the stator frame.

A stator core piece is disclosed for a gearless drive of a tube mill, the stator core piece comprising: a first stator core piece configured for a form-fitting connection with a second stator core piece.

A method is disclosed for producing a stator core for a gearless drive of a tube mill, the method comprising: a) providing a plurality of stator core pieces; and b) connecting stator core pieces to one another to form the stator core.

### BRIEF DESCRIPTION OF THE DRAWINGS

In the following text, exemplary embodiments will be explained in more detail in conjunction with the figures. The figures each show a radial section transversely with respect to an axis of rotation of a tube mill through a stator core, the stator core being subdivided into four stator core pieces wherein:

FIG. 1 shows stator core pieces connected to one another by preloaded notched toothing; and

FIG. 2 shows stator core pieces connected to one another by screw connections.

The designations used in the drawings are summarized in the list of designations. In principle, identical parts are provided with the same designations

### DETAILED DESCRIPTION

The present disclosure is directed to exemplary embodiments which can provide a stator of sufficient stiffness with reduced expenditure on material for a gearless drive of a tube mill, the stator having a stator core which is subdivided into stator core pieces and a stator frame arranged radially outside the stator core.

In an exemplary embodiment, a stator core is disclosed for a gearless drive of a tube mill. Stator core pieces can be connected to one another in the direction of rotation of the tube mill in such a way that a force or a moment can be transmitted directly, which means independently of a stator frame. Due to the resultant increased stiffness of the stator core, it is possible to reduce the expenditure on material for the stator frame and the expenditure on material for the stator, with a constant stiffness of the stator. The connecting direction can be defined by the position of the stator core pieces in relation to one another and is not necessarily identical to the direction in which the connection can absorb forces.

An exemplary embodiment of the stator core relates to a form-fitting connection between two of the stator core pieces. This means that, between the two stator core pieces, there is some form of undercut such that partial contours of the two stator core pieces interlock and, when the connection is loaded, surface pressures occur on the partial contours. As a result, the stator core pieces are loaded in compression.

A further exemplary embodiment relates to a bolt, pin or rivet connection such as a screw connection between two of the stator core pieces, in order in this way to permit loosening of the connection. This also can include the use of an additional element, such as a plate or a clamp.

A further exemplary embodiment relates to a toothing such as notched toothing between two of the stator core pieces. In this case, the toothing can include round partial contours. The toothing permits simple production of the connection.

A further exemplary embodiment relates to a dovetail connection between two of the stator core pieces. As a result, tensile forces can also be absorbed in addition to compressive forces.

A further exemplary embodiment relates to an integral connection between two of the stator core pieces, such as a welded, brazed or adhesively bonded connection. As a result, the occurrence of notch effects in the connection is minimized.

A further exemplary embodiment relates to a frictional connection, which can also be designated a force-fitting connection, such as a clamp or press connection. As a result, overloading of the connection is can be tolerated, because destruction-free slippage in the event of an overload is possible.

A further exemplary embodiment relates to a form-fitting connection between two of the stator core pieces in which a frictional connection additionally occurs. This combination of form fit and frictional fit has both a static and a dynamic load-bearing ability.

A further exemplary embodiment relates to preloaded notched toothing between two of the stator core pieces, which can be preloaded by a tensile force element such as a cable, wire or belt. This connection can be very simple to make.

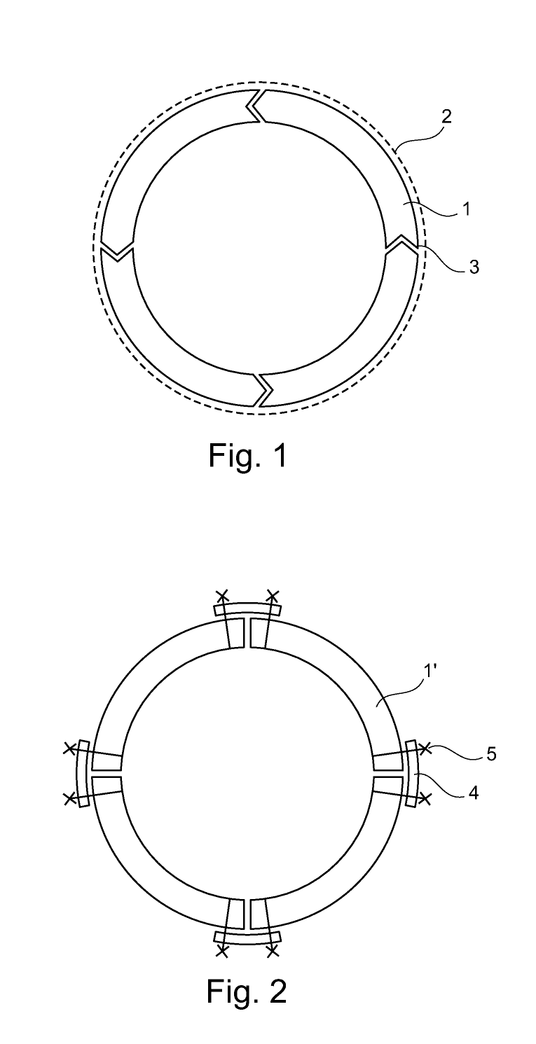

FIG. 1 shows a stator core in a radial section. The stator core is circular and subdivided into four stator core pieces 1. The stator core is at least partly made of a magnetizable material, such as steel, and to hold suitable stator windings, which are not shown in FIG. 1.

The stator core pieces 1 can each have a notch-like depression at a first end, and a notch-like protrusion at a second end. The notch-like depressions and protrusions can have an identical partial contour such that, given a circular arrangement of the stator core pieces 1, in each case a depression of a stator core piece 1 and a protrusion of an adjacent stator core piece form notch-like contact planes and form notched toothing 3.

Radially outside the circular arrangement of stator core pieces 1 there is a cable 2, which loads the stator core pieces 1 against one another in tension. A closed circular ring with a high stiffness is thus produced.

The circular shape of the stator core can alternatively also be implemented by other geometries. In exemplary embodiments described herein, the only restriction on the freedom of configuration is a quasi rotationally symmetrical shape of the stator core, in order to permit trouble-free rotation of a mill body. Furthermore, the number of stator core pieces can be varied as desired.

It is further also possible to provide stator core pieces with only depressions or protrusions at each of the two ends of the stator core pieces such that, in a circular arrangement of the stator core pieces, in each case a depression is grouped with a protrusion. The use of other partial contours for the toothing, such as with a plurality of depressions and protrusions at one end, is also possible. It is merely recommended to take care that undercutting of the stator core pieces is ensured.

The loading of the stator core pieces can also be carried out by means of other tensile force elements such as a wire, belt or screws in the tangential direction. The tensile force elements can also be present in the stator core pieces or radially within the circular arrangement of the stator core pieces.

FIG. 2 shows stator core pieces 1 having straight ends, such that, in a circular arrangement of the stator core pieces 1, contact surfaces in the radial direction are produced. Radially outside the circular arrangement of the stator core pieces 1, in the region of the contact surfaces, plates 4 are positioned such that the plates 4 overlap the respective stator core pieces 1 of a contact surface in the tangential direction and are connected to the stator core pieces 1 in the radial direction by means of screws 5.

It is also possible for stator core pieces having oblique ends to be used. It is further possible that the stator core pieces do not touch but form a space. It is possible to dispense with a plate if the stator core pieces themselves overlap one another or the screw fixing is carried out in the tangential direction. The screw connections can be preloaded in the radial and tangential direction and thus lead to an additional frictional connection.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF DESIGNATIONS

1, 1′ Stator core piece

2 Cable

3 Notched toothing

4 Plate

5 Screw

1. A stator core for holding stator windings for a gearless drive of a tube mill, the stator core comprising:
a stator core, together with a stator frame, forming a stator for a gearless drive for a tube mill; and
stator core pieces being assembled to form the stator core, the stator core pieces being connected to one another in an intended direction of rotation of the tube mill, independently of the stator frame.

2. The stator core as claimed in claim 1, comprising:
a form fit for connecting two of the stator core pieces to each other.

3. The stator core as claimed in claim 2, comprising:
a bolt, pin or rivet connection for connecting two of the stator core pieces to each other.

4. The stator core as claimed in claim 2, comprising:
toothing for connecting two of the stator core pieces to each other.

5. The stator core as claimed in claim 2, comprising:
a dovetail connection for connecting two of the stator core pieces to each other.

6. The stator core as claimed in claim 1, comprising:
an integral fit for connecting two of the stator core pieces to each other.

7. The stator core as claimed in claim 1, comprising:
a frictional fit for connecting two of the stator core pieces to each other.

8. The stator core as claimed in claim 2, comprising:
a frictional connection for connecting the two stator core pieces to each other, in addition to the form-fit connection.

9. The stator core as claimed in claim 8, comprising:
a preloaded screw connection for connecting the two stator core pieces to each other.

10. The stator core as claimed in claim 8, wherein the two stator core pieces are configured for connection to each other by preloaded notched toothing.

11. The stator core as claimed in claim 10, wherein the preloaded notched toothing is preloaded in a direction of intended rotation of the tube mill by a tensile force element.

12. A stator core piece for a gearless drive of a tube mill, the stator core piece comprising:
a first stator core piece configured for a form-fitting connection with a second stator core piece.

13. The stator core piece as claimed in claim 12, wherein the first stator core piece is configured with a screw connection, or with a notched toothing connection with the second stator core piece.

14. A method for producing a stator core for a gearless drive of a tube mill, the method comprising:
a) providing a plurality of stator core pieces; and
b) connecting stator core pieces to one another to form the stator core.

15. The stator core as claimed in claim 5, comprising:
a frictional connection for connecting the two stator core pieces to each other, in addition to the form-fit connection.
